(19) United States
(12) Patent Application Publication
(10) Pub. No.: US 2020/0137224 A1
(43) Pub. Date: Apr. 30, 2020

(54) COMPREHENSIVE LOG DERIVATION USING A COGNITIVE SYSTEM

(71) Applicant: International Business Machines Corporation, Armonk, NY (US)

(72) Inventors: Sarbajit K. Rakshit, Kolkata (IN); Martin G. Keen, Cary, NC (US); James E. Bostick, Cedar Park, TX (US); John M. Ganci, Jr., Raleigh, NC (US)

(21) Appl. No.: 16/176,507

(22) Filed: Oct. 31, 2018

(51) Int. Cl. H04M 3/42; G10L 17/06; G10L 17/00; G06F 17/27

(52) U.S. Cl. CPC H04M 3/42; G10L 17/06; G10L 17/005; H04M 2242/28; H04M 2201/60; H04M 2203/256; H04M 2203/551; G06F 17/278

(57) ABSTRACT

Disclosed embodiments provide techniques for generating a summary of a voice call between two or more participants. Computer-implemented natural language processing analyzes a call transcript and generates a summary and one or more keywords associated with the transcript. The summary and keywords are included in call log history entries, allowing a user to conveniently review a summary of what was discussed on a previous voice call. Embodiments interface with a teleconference system to include assets associated with the call, such as shared documents, images, and other media files.

### FIELD

Embodiments of the invention relate to telephony, and, more particularly, to a cognitive call history log deriving call topic, summary, and assets.

### BACKGROUND

Modern telephone devices retain a call history listing incoming and outgoing phone calls. For each call, this call history records data such as the phone number connected to, date/time stamp of call, and length of the call. Call history is typically organized in reverse chronological order. Telephone logs can be valuable tools for keeping track of previous conversations and teleconferences. Accordingly, there exists a need for improvements in call history indexing.

### SUMMARY

In one embodiment, there is provided a computer-implemented method for voice call summarization, comprising: converting voice communication utterances from a voice call to a text passage; performing an entity detection process on the text passage to generate one or more keywords; generating a scenario summary of the text passage; and creating a call log history entry, wherein the call log history entry includes the scenario summary.

In another embodiment, there is provided an electronic communication device comprising: a processor; a memory coupled to the processor, the memory containing instructions, that when executed by the processor, perform the steps of: converting voice communication utterances from a voice call to a text passage; performing an entity detection process on the text passage to generate one or more keywords; generating a scenario summary of the text passage; and creating a call log history entry, wherein the call log history entry includes the scenario summary.

In yet another embodiment, there is provided a computer program product for an electronic communication device comprising a computer readable storage medium having program instructions embodied therewith, the program instructions executable by a processor to cause the electronic communication device to perform the steps of: converting voice communication utterances from a voice call to a text passage; performing an entity detection process on the text passage to generate one or more keywords; generating a scenario summary of the text passage; and creating a call log history entry, wherein the call log history entry includes the scenario summary.

### BRIEF DESCRIPTION OF THE DRAWINGS

Features of the disclosed embodiments will be more readily understood from the following detailed description of the various aspects of the invention taken in conjunction with the accompanying drawings.

FIG. 1 is an environment for embodiments of the present invention.

FIG. 2 is a block diagram of a client device used with embodiments of the present invention.

FIG. 3 is an exemplary call log history in accordance with embodiments of the present invention.

FIG. 4A is an exemplary call log history entry showing additional details.

FIG. 4B shows the call log history entry of FIG. 4A after machine translation.

FIG. 5 shows an exemplary call log history entry showing keywords.

FIG. 6 is a flowchart indicating process steps for embodiments of the present invention.

FIG. 7 shows an example of presentation keyword generation from a shared desktop image in accordance with embodiments of the present invention.

FIG. 8 shows an exemplary call log history entry showing presentation keywords.

FIG. 9 shows an exemplary call topic log in accordance with embodiments of the present invention.

FIG. 10 shows an exemplary call log history for a topic in accordance with embodiments of the present invention.

FIG. 11 shows an example of disambiguation in accordance with embodiments of the present invention.

FIG. 12 shows an example of a dispersion analysis in accordance with embodiments of the present invention.

FIG. 13 shows an example of a bigram analysis in accordance with embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the Figures may be omitted, or illustrated not-to-scale, for illustrative clarity.

### DETAILED DESCRIPTION

Disclosed embodiments provide techniques for generating a summary of a voice call between two or more participants. Computer-implemented natural language processing analyzes a call transcript and generates a call summary with one or more keywords associated with the transcript. The call summary (and keywords) are included in call log history entries, allowing a user to conveniently review a summary of what was discussed on a previous voice call. Embodiments interface with a teleconference system to include assets associated with the call, such as shared documents, images, and other media files.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, or elements.

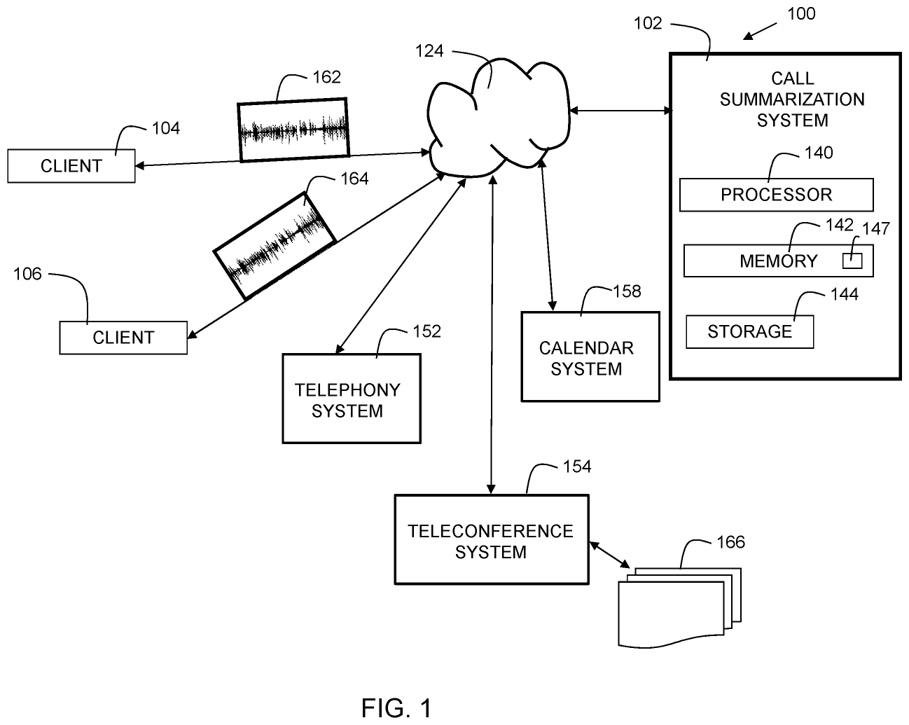

FIG. 1 is an environment 100 for embodiments of the present invention. Call summarization system 102 comprises a processor 140, a memory 142 coupled to the processor 140, and storage 144. System 102 is an electronic communication device. The memory 142, contains instructions 147, that when executed by the processor 140, perform embodiments of the present invention. Memory 142 may include dynamic random access memory (DRAM), static random access memory (SRAM), magnetic storage, and/or a read only memory such as flash, EEPROM, optical storage, or other suitable memory. In some embodiments, the memory 142 may not be a transitory signal per se. In some embodiments, storage 144 may include one or more magnetic storage devices such as hard disk drives (HDDs). Storage 144 may additionally include one or more solid state drives (SSDs).

System 102 is connected to network 124, which is the Internet, a wide area network, a local area network, or other suitable network. Telephony system 152 is also connected to the network 124. This system enables the connecting of phone calls. Telephony system 152 can be POTS, PBX, VoIP, or other suitable type.

Calendar system 158 is connected to the network 124. This system allows a user to configure and store items on a calendar/schedule. A user can create entries such as meetings, deadlines, classes, etc. In some embodiments, the calendaring system is a computer hosting Microsoft® Outlook®.

Teleconference system 154 is connected to network 124. This system allows users to conference with one another remotely. In some embodiments, it can be a system such as WebEx, GoToMeeting, or another similar type of teleconference system. Items 166 are documents associated with a meeting, such as presentation slides (e.g., via PowerPoint®), text documents (e.g., via Word® documents), spreadsheets (e.g., via Excel®), or images (e.g., jpeg, .png,), etc. These items may be stored within system 154 or linked to in system 154.

Client devices 104 and 106 are connected to network 124. Client devices 104 and 106 are user computing devices, such as tablet computers, laptop computers, desktop computers, smartphones, PDAs, or other suitable devices that can handle incoming and outgoing voice calls. Audio data streams 162 and 164 originate from client devices 104 and 106, respectively, and may contain voice utterances as part of telephone conversations. Although two client devices are shown, in implementations, more or fewer client devices can be in communication with the system shown over the network 124.

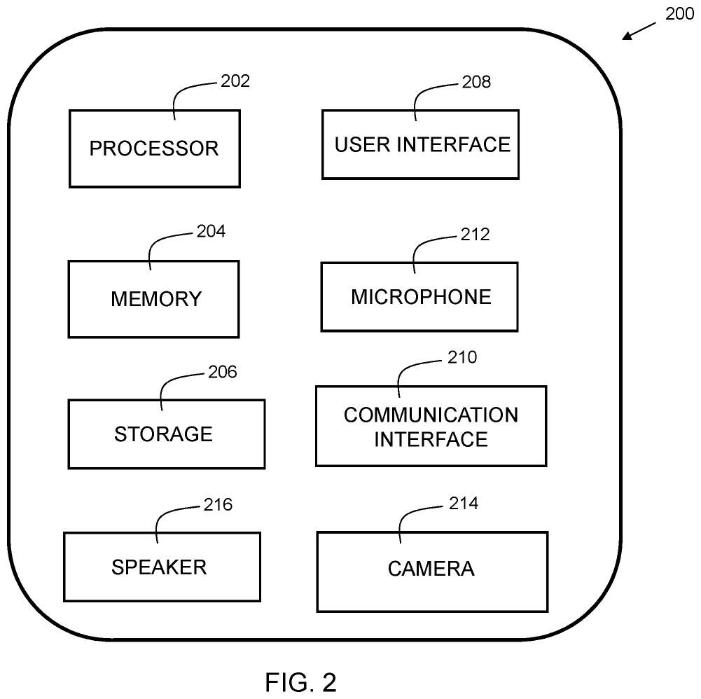

FIG. 2 is a block diagram of a client device 200 used with embodiments of the present invention. Device 200 is an electronic communication device. Device 200 includes a processor 202, which is coupled to a memory 204. Memory 204 may include dynamic random access memory (DRAM), static random access memory (SRAM), magnetic storage, and/or a read only memory such as flash, EEPROM, optical storage, or other suitable memory. In some embodiments, the memory 204 may not be a transitory signal per se. In embodiments, device 200 may have multiple processors 202, and/or multiple cores per processor. The device 200 may execute an operating system that provides virtual memory management for the device 200. The processor 202 may have one or more cache memories therein.

Device 200 further includes storage 206. In embodiments, storage 206 may include one or more magnetic storage devices such as hard disk drives (HDDs). Storage 206 may additionally include one or more solid state drives (SSDs).

Device 200 further includes a user interface 208, examples of which include a liquid crystal display (LCD), a plasma display, a cathode ray tube (CRT) display, a light emitting diode (LED) display, an organic LED (OLED) display, or other suitable display technology. The user interface 208 may further include a keyboard, mouse, or other suitable human interface device. In some embodiments, user interface 208 may be a touch screen, incorporating a capacitive or resistive touch screen in some embodiments.

Device 200 further includes a communication interface 210. The communication interface 210 may be a wired communication interface that includes Ethernet, Gigabit Ethernet, or the like. In embodiments, the communication interface 210 may include a wireless communication interface that includes modulators, demodulators, and antennas for a variety of wireless protocols including, but not limited to, Bluetooth®, Wi-Fi, and/or cellular communication protocols for communication over a computer network.

Device 200 further includes a microphone 212, speaker 216, and camera 214. Speaker 216 may be powered or passive. Camera 214 may have a flash.

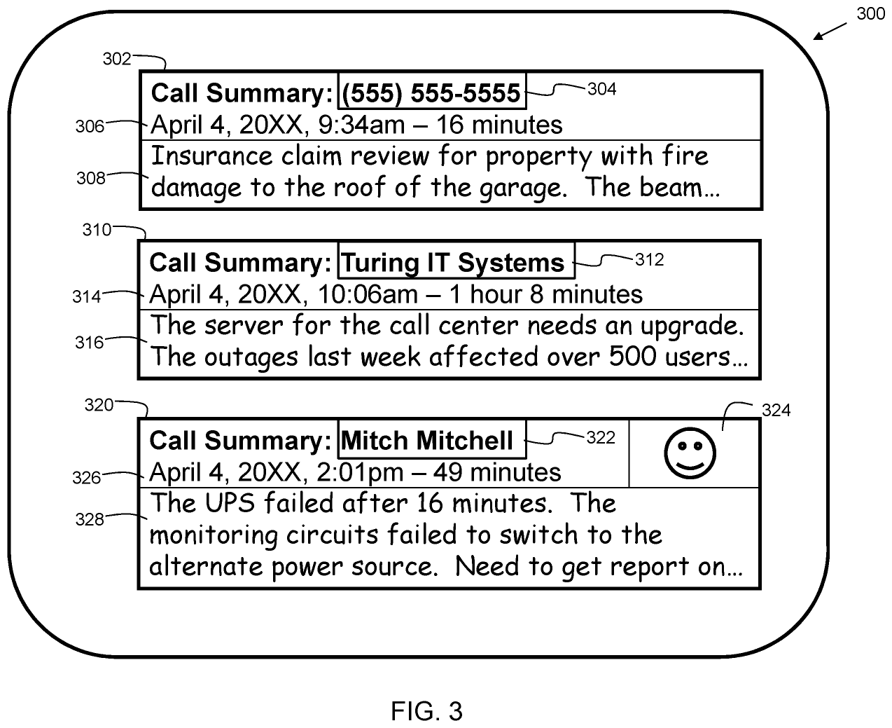

FIG. 3 is an exemplary call log history 300 in accordance with embodiments of the present invention. Embodiments include retrieving contact information from a caller ID system and/or a contact list in a contact database based on a caller identifier. The caller identifier is a numeric or alphanumeric string that is used to identify a caller. In embodiments, the caller identifier can be a telephone number, email address, VoIP ID, or other suitable identifier. Using the caller identifier, other metadata such as name, location, and an associated image may also be retrieved and displayed. The contact information is included in a call log history entry. In some embodiments, the contact information is a contact name and/or a contact image, or other identifying information such as a phone number. In the example, there are three call log history entries 302, 310, and 320. Each entry (call summary) has various elements including, for example, contact information (name and image), date and duration of the call, a scenario summary (computer-generated summarization of the call transcript), and company name.

Entry 302 has contact information 304, which is a telephone number (outgoing, or incoming) detected via caller ID. It has the date and duration of the call 306 being Apr. 4, 20XX at 9:34 am for 16 minutes. At 308, there is a scenario summary generated from natural language processing of a speech-to-text transcription of the call.

Entry 310 has contact information 312, which is a company name detected from a contact database or caller ID. It has the date and duration of the call 314 being Apr. 4, 20XX at 10:06 am for 1 hour 8 minutes. At 316, there is a scenario summary generated from natural language processing of a speech-to-text transcription of the call.

Entry 320 has contact information 322, which is a person's name detected from a contact database or caller ID. It has the date and duration of the call 326 being Apr. 4, 20XX at 2:01 pm for 49 minutes. At 328, there is a scenario summary generated from natural language processing of a speech-to-text transcription of the call. At 324, there is an image associated with the caller extracted from the contact database.

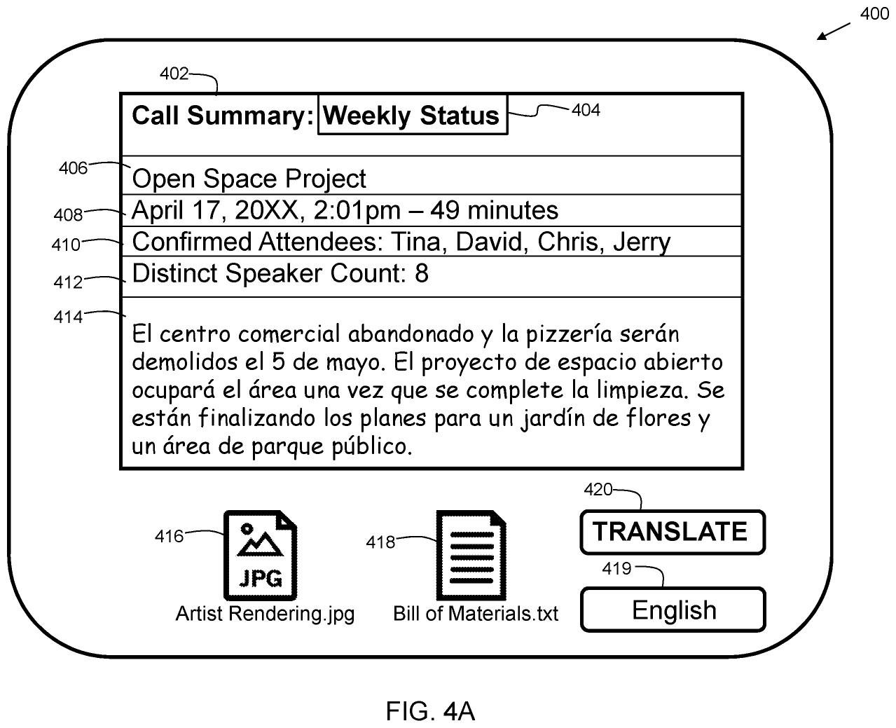

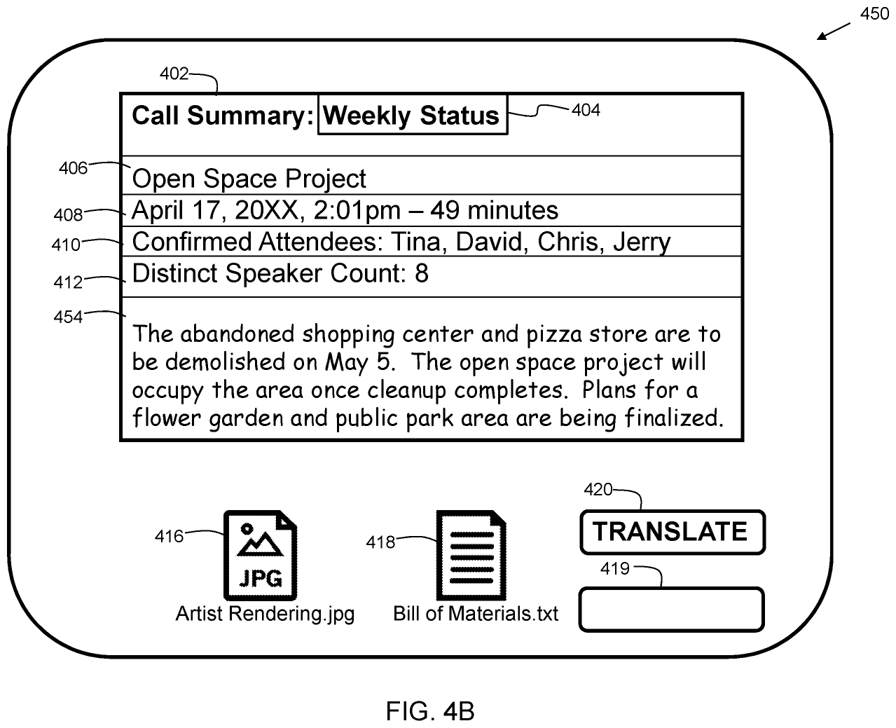

FIG. 4A is an exemplary call log history entry 400 showing additional details. Some embodiments include retrieving meeting information associated with a voice call from a teleconference system or calendar system. A call summary 402 includes a meeting title that is extracted from the meeting information and included in the call log history entry. At 404, there is the title derived from a calendar invitation. At 406, there is a secondary title created by the system based on the generated scenario summary of the call transcript. Accordingly, even if a meeting title is generic, such as “weekly meeting,” more specific information may be provided to a user from the secondary title. At 408, there is the date and duration of call, which is Apr. 17, 20XX at 2:01 pm for 49 minutes.

Some embodiments further include extracting one or more electronic file references from the meeting information. Those electronic file references are included in the call log history entry. The electronic file references can be links, shortcuts, or digital assets (files) associated with the meeting. Such electronic file references can be attached to the meeting invite or be in an associated shared online folder (e.g., Google Drive), or be accessed in any other suitable manner. In the example, there are two electronic file references, namely, an image 416 titled “Artist Rendering.jpg” and a text document titled “Bill of Materials.txt.”

Some embodiments further include extracting a meeting attendee list from the meeting information. The meeting attendee list is included in the call log history entry. In the example, the confirmed attendees are shown at 410, being Tina, David, Chris, and Jerry.

Some embodiments further include performing a voiceprint analysis on the voice communication utterances during the meeting. A distinct speaker count is computed based on unique voiceprints detected from the voice print analysis. The distinct speaker count is included in the call log history entry. In the example, at 412, there is the distinct speaker count of “8”. Note that the distinct speaker count can be greater than the number of “confirmed attendees.” As an example, Jerry is on a conference call with remote attendees Tina, David, and Chris. Jerry is taking the call in a conference room where four other employees join him locally. Accordingly, there are eight people participating in actuality. The system can perform voiceprint analysis to determine that five people are actually speaking on Jerry's connection (Jerry plus four other people) and then can add those five to the count of Tina, David, and Chris for a total of eight speakers.

In some embodiments, the call log history entry can be in the same language used during the meeting, or can be translated to another. The translation can be performed by machine translation. This can be preset by the user through a menu in the system (102 of FIG. 1). Alternatively, it can be executed after initial presentation of the call log history entry via the user selecting control (button) 420 after entering the desired language into field 419. These are examples, and another suitable mechanism for translation execution is included within the scope of the invention.

FIG. 4B shows call log history entry 450 (of FIG. 4A after machine translation is performed). In the example, the user entered “English” into field 419 and then pressed control button 420 of FIG. 4A. This instructed the system (102 of FIG. 1) to translate the scenario summary 414 from Spanish to English at 454. This is useful for multinational conference calls where some people may not be completely fluent in the language of the conference call, and can translate the scenario summary to their native language for quicker/better understanding.

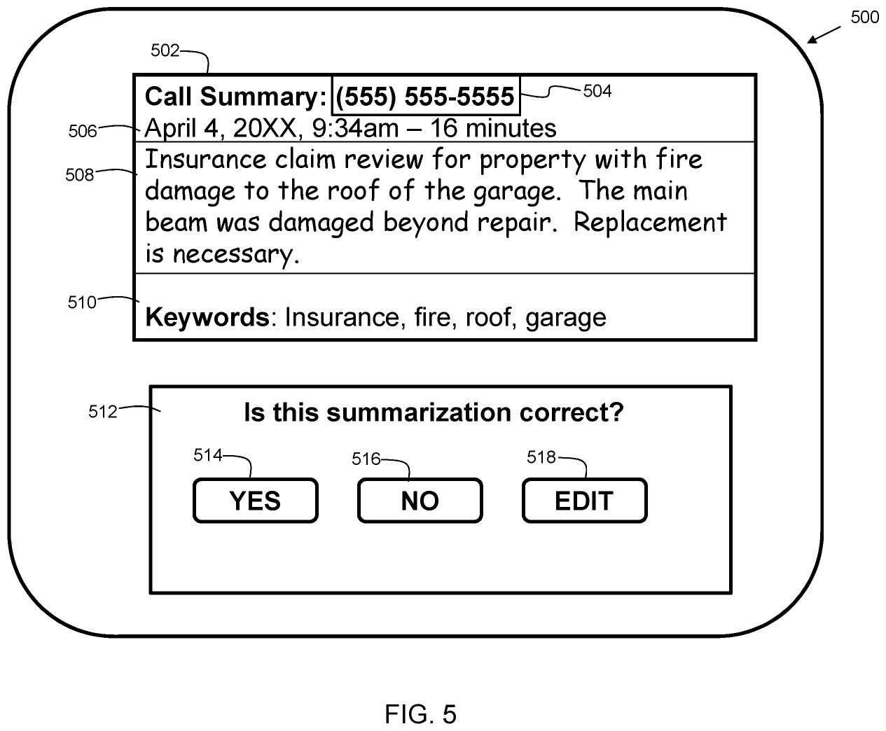

FIG. 5 shows an exemplary call log history entry (call summary) 500 showing keywords. In some embodiments, the system (102 of FIG. 1) may identify and extract keywords via NLP (natural language processing), OCR (optical character recognition), and/or other suitable technique from the call transcript or from the scenario summary. The one or more keywords are included in the call log history entry.

In the example, there is shown a call log history entry 502. At 504, there is the caller identifier, which is a telephone number, name of a person, name of a company, etc. In some embodiments, instead of a telephone number, the caller identifier can be a user identifier such as a Skype ID, Slack ID, etc. At 506, there is the date and duration of the call, which is Apr. 4, 20XX at 9:34 am for 16 minutes. At 508, there is a scenario summary. At 510, keywords detected from the scenario summary are shown. They include here, “insurance,” “fire,” “roof,” and “garage.” The keywords may be derived from the scenario summary based on entity detection and/or other NLP methods.

Some embodiments include machine learning capabilities. At 512, there is a user confirmation dialog box for obtaining user feedback. It presents a question to the user as to whether the call summary is correct. If so, the user can respond positively, by selecting the “yes” button 514. If not, the user can respond negatively using the “no” button 516. In some embodiments, the user can choose to edit the call summary or remove keywords by selecting the “edit” button 518. Over time, using Bayesian filters, machine learning or other techniques, the creation of the summaries could improve by considering user feedback.

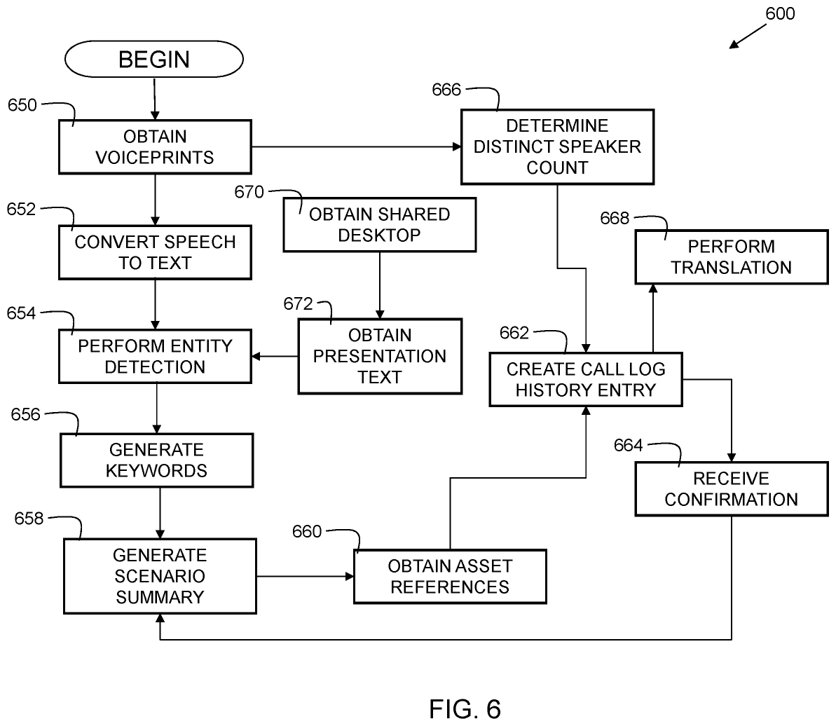

FIG. 6 is a flowchart 600 indicating process steps for embodiments of the present invention. At 650, voiceprints are obtained. A person's voice is unique because of the shape of his/her vocal cavities and the way they move their mouth when speaking. Data used in a voiceprint is a sound spectrogram, which is essentially a graph that shows a sound's frequency on the vertical axis and time on the horizontal axis. Different speech sounds create different shapes within the graph. Spectrograms also use colors or shades of grey to represent the acoustical qualities of sound.

At 652, the voiceprints are converted from speech to text. This is performed using a software program, such as IBM® Watson®, resulting in a transcript (also referred to as “text passage” interchangeably herein) of the call.

At 654, entity detection is performed on the transcript. The entity detection can include noun identification, followed by identifying a subset of nouns including proper nouns and nouns deemed to be topically pertinent. The entity detection can include sentence classification. The sentence classification can include analyzing sentences, based on lexical patterns and/or punctuation. The sentences can then be classified into a variety of categories.

At 656, keywords are generated based on the entity detection. The keywords can be based on frequency of occurrence, matching a predetermined list of defined keywords, and/or other criteria.

At 658, a scenario summary is generated. In embodiments, the scenario summary is derived from the entity detection. The entity detection can include extraction, which is the detection and preparation of named entity occurrences. The extraction phase includes POS (part of speech) tagging, tokenization, sentence boundary detection, capitalization rules and in-document statistics. The entity detection can further include noun identification, followed by identifying a subset of nouns including proper nouns, and nouns deemed to be topically pertinent. The extracted entities can be used as keywords within the call summary.

At 660, asset references are obtained. These are extracted, for example, from a shared desktop, if present, or an email invite including an attachment or link.

At 662, a call log history entry is created. This logs an entry for each call connected on the respective client device. It associates topic keywords and the scenario summary in a call summary, with each call for indexing and efficient retrieval of call information.

At 666, a distinct speaker count is determined. This is performed by analysis of the frequencies and other information in the detected voiceprints. In addition, the names and number of confirmed attendees can be taken into account as well. The distinct speaker count is indexed with the call log history.

At 670, a shared desktop used during the call is obtained. At 672, the presentation text from the shared desktop is obtained (e.g., by using OCR processing on an image of the shared desktop). The process then proceeds to block 654 where entity detection is performed.

At 668, a translation is performed on a summary of the call. This may be performed according to a preset that the user set, or in response to the user selecting a translate button.

At 664, a confirmation is received regarding the correctness of the summarization. This can originate from a selection made in a user confirmation dialog box such as 512 in FIG. 5. Some of the process steps shown in flowchart 600 are optional, and some embodiments may not include all the process steps shown in flowchart 600. In some embodiments, the order of the elements of the process may be modified.

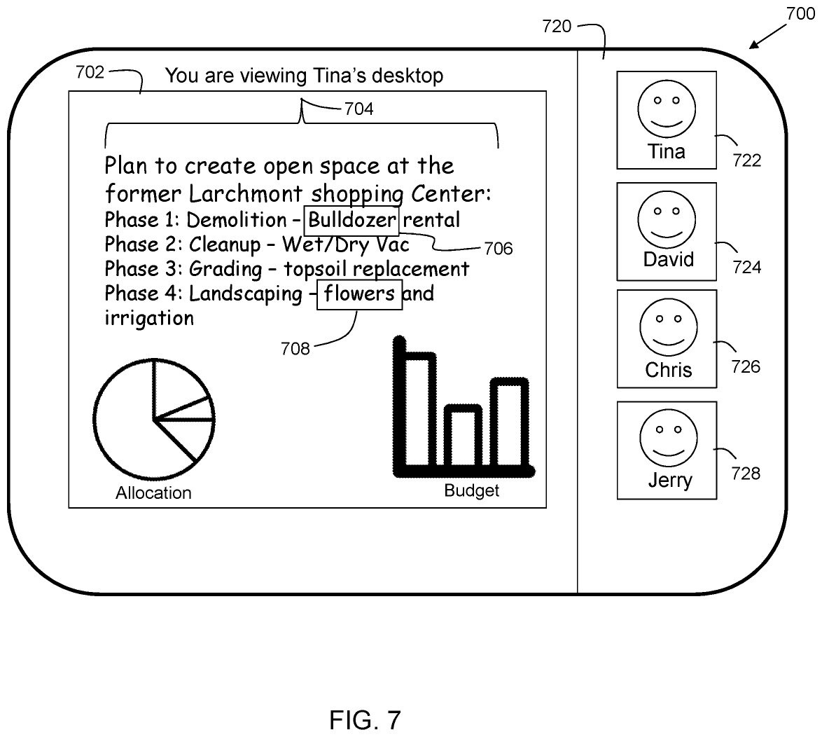

FIG. 7 shows an example of presentation keyword generation from a shared desktop image 700 in accordance with embodiments of the present invention. In some embodiments, a teleconference may use a shared desktop as a visual aid and for editing during the call. Some embodiments include obtaining a shared desktop image from the teleconference system. An optical character recognition process is performed on the shared desktop image to derive shared presentation text. An entity detection process is performed on the shared presentation text to generate one or more presentation keywords. The presentation keywords are included in the call log history.

In the example of FIG. 7, at 702, there is an example of a shared desktop. At 704, there is a text portion of a presentation. At 706, “bulldozer” is identified and at 708, “flowers” is identified, each as keywords. This can be performed based on frequency of occurrence, font size, and/or other factors. At 720, there is a participant pane showing the names and images of participants on the call. In the example, there is Tina 722, David 724, Chris 726, and Jerry 728.

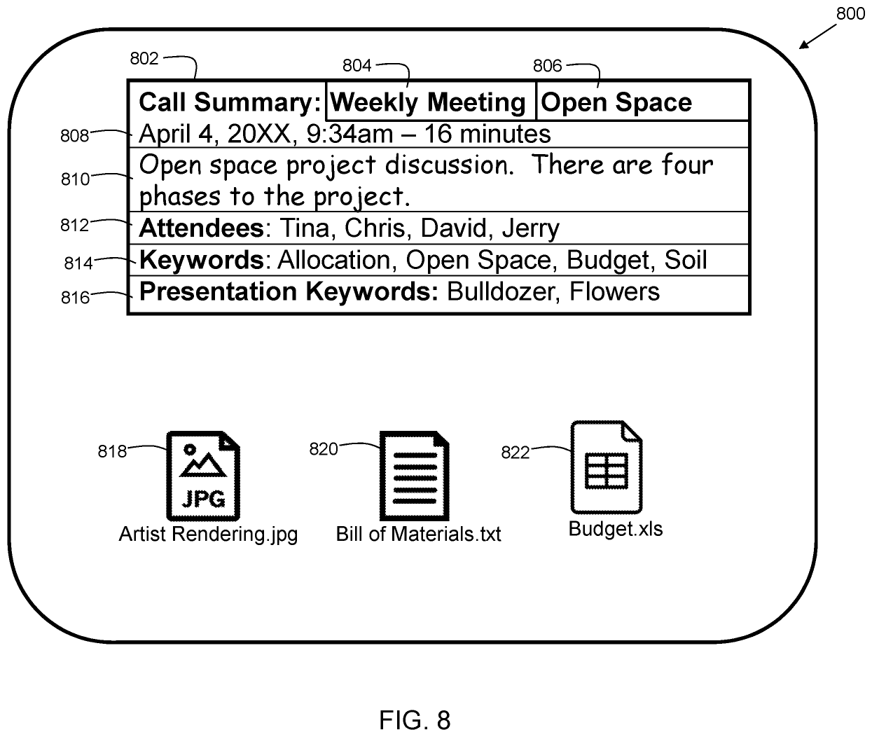

FIG. 8 shows an exemplary call log history entry 800 based on the meeting described in FIG. 7. Some embodiments include generating a secondary title based on the scenario summary, and including the secondary title in the call log history entry. At 802, there is a call history entry. At 804, there is a meeting title. This is derived from the calendar invite, email, calendar system, or teleconference system. At 806, there is a secondary title.

The calendar entry here includes time, duration, attendees, and keywords. At 808, there is a call time and duration, which is Apr. 4, 20XX at 9:34 am for 16 minutes. At 810, there is a scenario summary from natural language processing of a speech-to-text transcript. At 812, there is the list of attendees, which is Tina, David, Chris, and Jerry (722, 724, 726, and 728 of FIG. 7). At 814, there are keywords derived based on the call transcript, including “allocation,” “open space,” “budget,” and “soil.”

In some embodiments, presentation keywords are derived from the transcript or summary of the call. At 816, there are presentation keywords derived based on OCR, NLP, and/or other suitable technique (see 706 and 708 of FIG. 7), including “bulldozer,” and flowers.” These presentation keywords are scraped from text derived from a shared desktop used during the call on Apr. 4, 20XX.

In the example, electronic file references are included: image 818 titled “Artist Rendering.jpg,” text document 820 titled “Bill of Materials.txt,” and spreadsheet 822 titled “Budget.xls”. These were obtained from the calendar invite, or were opened/accessed on the shared desktop during the call on Apr. 4, 20XX.

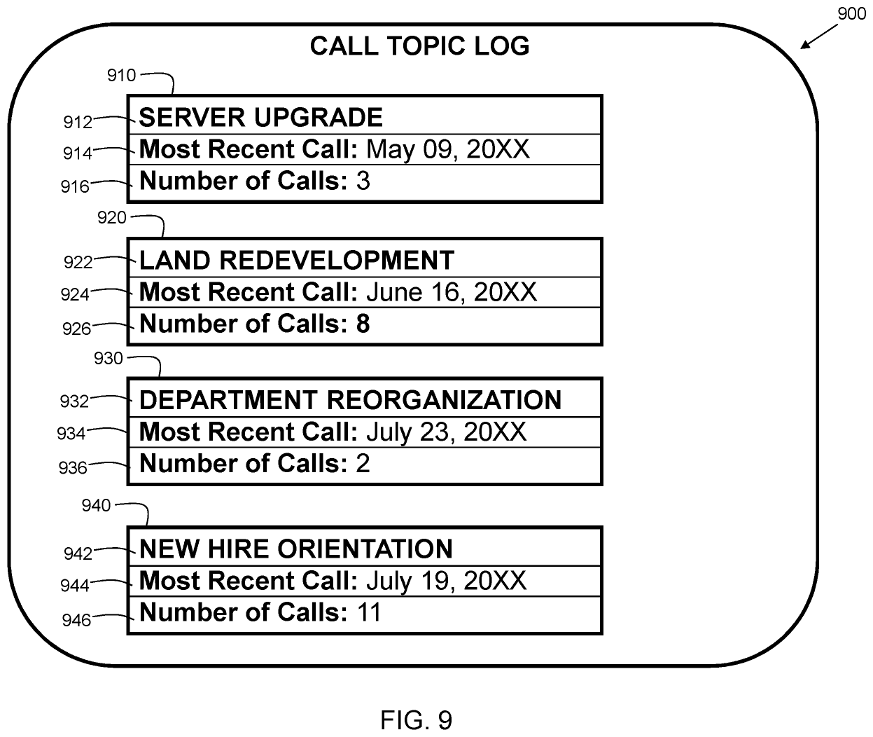

FIG. 9 shows an exemplary call topic log 900 in accordance with embodiments of the present invention. In some embodiments, calls may be organized by topic. Calls pertaining to a particular topic may be accessed by a user by selecting one of entries 910, 920, 930, and 940. In response to the selection, the call history of calls pertaining to that topic are presented on the user interface. For each call topic, there is shown the date/time of the most recent call for that topic and number of calls in the list associated with that topic. This may be for a preset time period such as one month, or adjustable by the user, for instance, to three days or one year. In the example, four topics are included in the call topic log. If the user selects any of entries 910, 920, 930, or 940, the list of calls for that topic will be presented.

The first entry is shown at 910. It relates to call topic 912, which is “SERVER UPGRADE”. For that topic, the most recent call is shown at 914 as May 9, 20XX. There were three recent calls relating to that topic as indicated at 916.

The second entry is shown at 920. It relates to call topic 922, which is “LAND REDEVELOPMENT”. For that topic, the most recent call is shown at 924 as Jun. 16, 20XX. There were eight recent calls relating to that topic as indicated at 926.

The third entry is shown at 930. It relates to call topic 932, which is “DEPARTMENT REORGANIZATION”. For that topic, the most recent call is shown at 934 as Jul. 23, 20XX. There were two recent calls relating to that topic as indicated at 936.

The fourth entry is shown at 940. It relates to call topic 942, which is “NEW HIRE ORIENTATION”. For that topic, the most recent call is shown at 944 as Jul. 19, 20XX. There were 11 recent calls relating to that topic as indicated at 946.

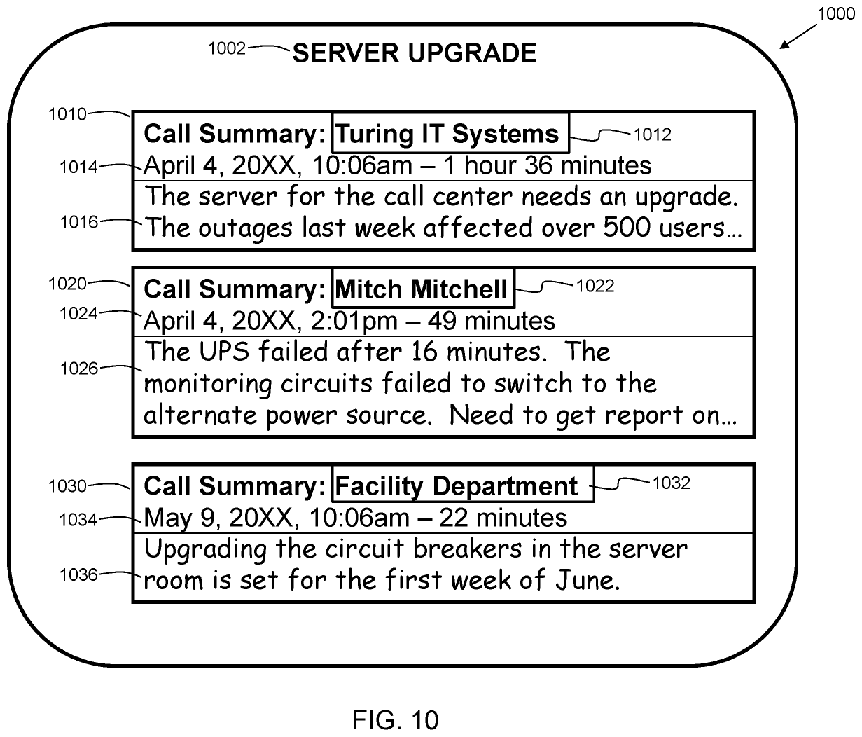

FIG. 10 shows an exemplary call log history 1000 for a topic in accordance with embodiments of the present invention. In the example, the user selects entry 910 on the history of FIG. 9. Accordingly, a list of calls pertaining to topic 912, “server upgrade” is presented. The title of the call log history is shown at 1002 (the topic selected).

A first call log entry 1010 shows the caller contact information at 1012 as company name, Turing IT Systems. At 1014, there is shown the call date and duration as Apr. 4, 20XX at 10:06 am for 1 hour 36 minutes. At 1016, there is shown the scenario summary.

A second call log entry 1020 shows the caller contact information at 1022 as personal name, Mitch Mitchell. At 1024, there is shown the call date and duration as Apr. 4, 20XX at 2:01 pm for 49 minutes. At 1026, there is shown the scenario summary.

A third call log entry 1030 shows the caller contact information at 1012 as company department name, Facility Department. Some embodiments recognize a call imitated from an internal phone number, and associate the name of the department or other designation within the company as the contact information. At 1034, there is shown the call date and duration as May 9, 20XX at 10:06 am for 22 minutes. At 1036, there is shown the scenario summary.

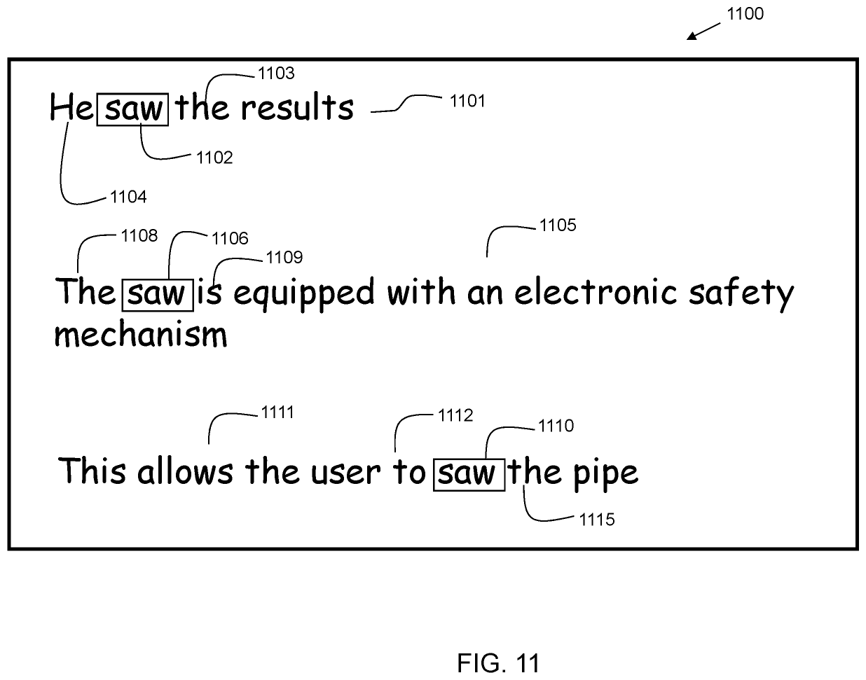

FIG. 11 shows an example of disambiguation in accordance with embodiments of the present invention. Disambiguation is one of the processes that may be utilized in embodiments of the present invention. As part of content ingest of the speech-to-text created transcript of the call, text may be tokenized into words and tagged with parts of speech. For some words, there can be more than one meaning and/or part of speech. FIG. 11 shows a disambiguation example with the word “saw.” In phrase 1101, the word “saw” 1102 is a past tense verb. In embodiments, a machine learning natural language analysis module may identify the prior token 1104 to the word “saw” as a pronoun, and the following token 1103 as an article. In training a classifier, the pattern of pronoun-token-article may be associated with a verb, and thus the token is interpreted as a verb.

In phrase 1105, the word “saw” 1106 is a noun for a cutting tool. In embodiments, a machine learning natural language analysis module may identify the prior token 1108 to the word saw as an article, and the following token 1109 as a verb. In training a classifier, the pattern article-token-verb may be associated with a noun, and thus the token is interpreted as a noun.

In phrase 1111, the word “saw” 1110 is a verb for cutting using a tool. In embodiments, a machine learning natural language analysis module may identify the prior token 1112 to the word “saw” as part of an infinitive form, and the following token 1115 as an article. In training a classifier, the pattern “to”-token-article may be associated with a verb, and thus the token is interpreted as a verb. These classifiers and techniques for disambiguation are examples, and other classifiers and techniques are possible.

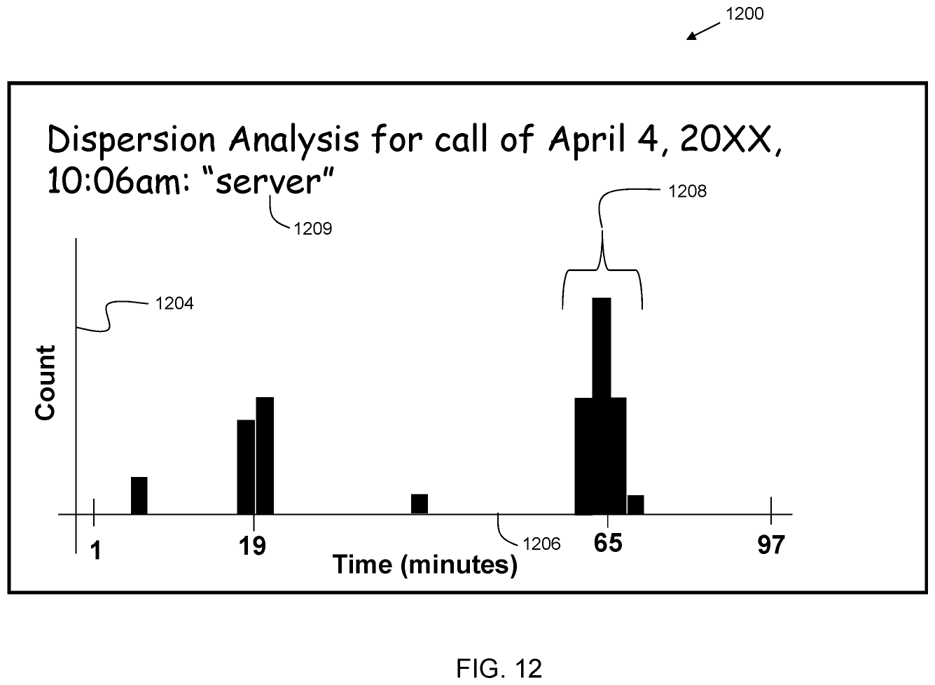

FIG. 12 shows an example of a dispersion analysis in accordance with embodiments of the present invention. In a call on Apr. 4, 20XX, a particular word may have a non-uniform distribution within the call. In the example 1200, a dispersion analysis is performed for the word “server” 1209 within the speech-to-text created transcript of the call. A graph comprises a horizontal axis 1206 representing a time within the call duration, and a vertical axis 1204 representing a number of occurrences of word “server” 1209 in the call transcript. As can be seen in the graph, the presence of the word “server” 1209 is concentrated in certain time periods. A maximum concentration 1208 is identified in the area around minute 65. In embodiments, transcript portions in proximity to the maximum concentration of the dispersion analysis are presented in a call log indicating relevant portions of the conversation. Thus, in this example, if the transcript includes the word at a point in time, for example minute 65, then passages from the transcript of the call at or near minute 65 may be retrieved for display in the call log, and indicate approximately when during the call the topic pertaining to a given word was discussed. Thus, in some embodiments, the call log entry may indicate the approximate point within the call where a topic is discussed. This can be useful when a call covers multiple topics. As an example, the call log may indicate that the topic of “server” was discussed around minutes 63-66 of the call, based on the dispersion analysis.

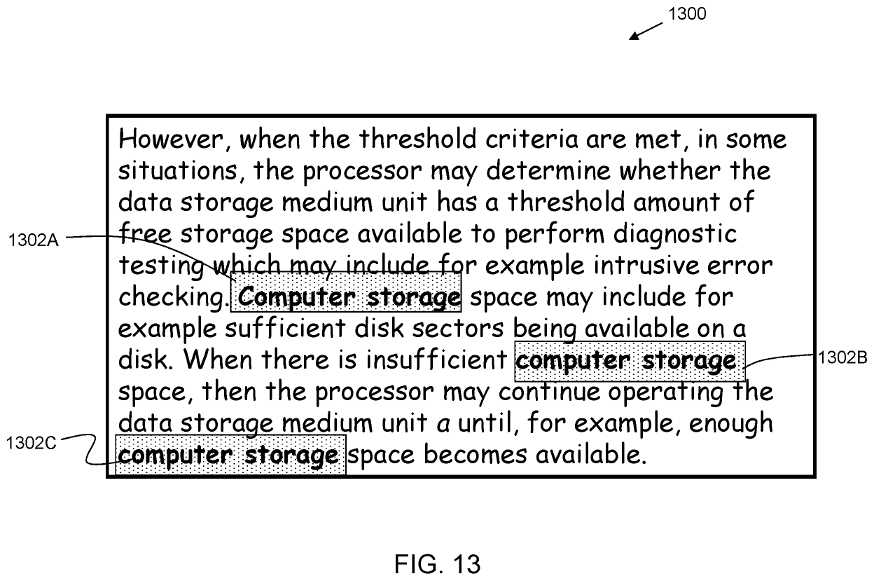

FIG. 13 shows an example of a bigram analysis 1300 in accordance with embodiments of the present invention. In a bigram analysis, a pair of words in a particular order may be searched within a speech-to-text created transcript of a call. In this example, the bigram “computer storage” is searched within the call transcript. Three occurrences, indicated as 1302A, 1302B, and 1302C are present in the text passage. In embodiments, the usage of bigrams, trigrams, or more generally, n-grams (number=n), may be used to improve relevance in searching a text excerpt of a call transcript. Thus, embodiments include performing a computerized natural language analysis process to derive keywords from the transcript by performing a bigram analysis.

As can now be appreciated, disclosed embodiments provide improvements in call log history management. Natural language processing is used to identify entities, generate keywords, and create summaries of call transcripts. The summaries and keywords can be stored in the call log. This allows a user to quickly see the topics discussed during various calls. Additionally, embodiments integrate with a teleconference system to reference assets such as presentations shown and/or files shared during the voice call. In this way, a user has relevant information at his/her fingertips regarding previous voice calls. Thus, disclosed embodiments can improve the technical field of call log history management.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

1. A computer-implemented method for voice call summarization, comprising:
converting voice communication utterances from a voice call to a text passage such that the text passage is a speech-to-text transcript of the voice call;
performing an entity detection process on the text passage to generate one or more keywords extracted from the text passage based on a topic of the voice call determined by natural language processing based on a frequency of occurrence of the keywords in the text passage relative to other words in the text passage;
generating a scenario summary of the text passage based on the one or more keywords, the scenario summary being a computer-generated summarization of the text passage that is an abstract of a lamer text passage that is generated from natural language processing of the speech-to-text transcript of the voice call;
creating a call log history entry in a call log that logs an entry for each call connected on a respective client device, wherein the call log history entry includes the scenario summary; and
organizing the call log history entry into a call topic log having a list of call log history entries that pertain to the topic.

2. The computer-implemented method of claim 1, further comprising:
performing a disambiguation process to tad words in the text passage from the converting with parts of speech;
performing a dispersion analysis to determine words within the text passage from the converting that have a non-uniform distribution within the voice call;
performing a bigram analysis to identify bigrams within the text passage;
performing a computerized natural language analysis process to derive the one or more keywords from the text passage based on results of the disambiguation process, the dispersion analysis, and the bigram analysis; and
including the one or more keywords in the call log history entry.

3. The computer-implemented method of claim 1, further comprising, retrieving contact information from a contact list based on a caller identifier, and including the contact information in the call log history entry.

4. The computer-implemented method of claim 3, wherein the contact information includes a contact name.

5. The computer-implemented method of claim 1, further comprising:
retrieving meeting information associated with the voice call from a teleconference system;
extracting a meeting title from the meeting information; and
including the meeting title in the call log history entry.

6. The computer-implemented method of claim 5, further comprising:
extracting one or more electronic file references from the meeting information; and
including the one or more electronic file references in the call log history entry.

7. The computer-implemented method of claim 5, further comprising:
extracting a meeting attendee list from the meeting information; and
including the meeting attendee list in the call log history entry.

8. The computer-implemented method of claim 7, further comprising:
performing a voiceprint analysis on the voice communication utterances;
computing a distinct speaker count based on unique voiceprints detected from the voice print analysis; and
including the distinct speaker count in the call log history entry.

9. The computer-implemented method of claim 6, further comprising:
generating a secondary title based on the scenario summary, the secondary title being a user-readable label that describes a content of the scenario summary; and
including the secondary title in the call log history entry,
wherein the organizing further includes organizing the list of call log history entries in the call topic log based on the secondary title.

10. The computer-implemented method of claim 6, further comprising:
obtaining a shared desktop image from the teleconference system;
performing an optical character recognition process on the shared desktop image to derive shared presentation text;
performing an entity detection process on the shared presentation text to generate one or more presentation keywords; and
including the presentation keywords in the call log history entry.

11. An electronic communication device comprising:
a processor;
a memory coupled to the processor, the memory containing instructions, that when executed by the processor, perform the steps of:
converting voice communication utterances from a voice call to a text passage such that the text passage is a speech-to-text transcript of the voice call;
performing an entity detection process on the text passage to generate one or more keywords extracted from the text passage that pertain to a topic of the voice call based on a frequency of occurrence of the keywords in the text passage relative to other words in the text passage;
generating a scenario summary of the text passage based on the one or more keywords, the scenario summary being a computer-generated summarization of the text passage that is an abstract of a lamer text passage that is generated from natural language processing of the speech-to-text transcript of the voice call;
creating a call log history entry in a call log that logs an entry for each call connected on a respective client device, wherein the call log history entry includes the scenario summary; and
organizing the call log history entry into a call topic log having a list of call log history entries that pertain to the topic.

12. The electronic communication device of claim 11, wherein the memory further comprises instructions, that when executed by the processor, perform the steps of:
performing a disambiguation process to tad words in the text passage from the converting with parts of speech;
performing a dispersion analysis to determine words within the text passage from the converting that have a non-uniform distribution within the voice call;
performing a bigram analysis to identify bigrams within the text passage;
performing a computerized natural language analysis process to derive the one or more keywords from the text passage based on results of the disambiguation process, the dispersion analysis, and the bigram analysis; and
including the one or more keywords in the call log history entry.

13. The electronic communication device of claim 11, wherein the memory further comprises instructions, that when executed by the processor, perform the steps of retrieving contact information from a contact list based on a caller identifier, and including the contact information in the call log history entry.

14. The electronic communication device of claim 11, wherein the memory further comprises instructions, that when executed by the processor, perform the steps of:
retrieving meeting information associated with the voice call from a teleconference system;
extracting a meeting title from the meeting information; and
including the meeting title in the call log history entry.

15. The electronic communication device of claim 14, wherein the memory further comprises instructions, that when executed by the processor, perform the steps of:
extracting a meeting attendee list from the meeting information; and
including the meeting attendee list in the call log history entry.

16. The electronic communication device of claim 15, wherein the memory further comprises instructions, that when executed by the processor, perform the steps of:
performing a voiceprint analysis on the voice communication utterances;
computing a distinct speaker count based on unique voiceprints detected from the voice print analysis; and
including the distinct speaker count in the call log history entry.

17. The electronic communication device of claim 14, wherein the memory further comprises instructions, that when executed by the processor, perform the steps of:
generating a secondary title based on the scenario summary, the secondary title being a user-readable label that describes a content of the scenario summary; and
including the secondary title in the call log history entry,
wherein the organizing further includes organizing the list of call log history entries in the call topic log based on the secondary title.

18. The electronic communication device of claim 14, wherein the memory further comprises instructions, that when executed by the processor, perform the steps of:
obtaining a shared desktop image from the teleconference system;
performing an optical character recognition process on the shared desktop image to derive shared presentation text;
performing an entity detection process on the shared presentation text to generate one or more presentation keywords; and
including the presentation keywords in the call log history entry.

19. A computer program product for an electronic communication device comprising a computer readable storage medium having program instructions embodied therewith, the program instructions executable by a processor to cause the electronic communication device to perform the steps of:
converting voice communication utterances from a voice call to a text passage such that the text passage is a speech-to-text transcript of the voice call;
performing an entity detection process on the text passage to generate one or more keywords extracted from the text passage that pertain to a topic of the voice call based on a frequency of occurrence of the keywords in the text passage relative to other words in the text passage;
generating a scenario summary of the text passage based on the one or more keywords, the scenario summary being a computer-generated summarization of the text passage that is an abstract of a lamer text passage that is generated from natural language processing of the speech-to-text transcript of the voice call;
creating a call log history entry in a call log that logs an entry for each call connected on a respective client device, wherein the call log history entry includes the scenario summary; and
organizing the call log history entry into a call topic log having a list of call log history entries that pertain to the topic.

20. The computer program product of claim 19, wherein the computer readable storage medium includes program instructions executable by the processor to cause the electronic communication device to perform the steps of:
retrieving meeting information associated with the voice call from a teleconference system;
extracting a meeting title from the meeting information;
extracting a meeting attendee list from the meeting information;
performing a voiceprint analysis on the voice communication utterances;
computing a distinct speaker count based on unique voiceprints detected from a voice print analysis;
including the meeting title, meeting attendee list, and distinct speaker count in the call log history entry.
